(19) United States
(12) Patent Application Publication
(10) Pub. No.: US 2019/0121028 A1
(43) Pub. Date: Apr. 25, 2019

(54) FIBER OPTIC CONNECTOR ASSEMBLY WITH IN-LINE SPLITTER

(71) Applicant: CORNING OPTICAL COMMUNICATIONS LLC, Hickory, NC (US)

(72) Inventors: Robert Elvin Barnette, JR., Hickory, NC (US); Joseph Clinton Jensen, Lawndale, NC (US); Kristine Alaina Johnson, Keller, TX (US); Hieu Vinh Tran, Charlotte, NC (US)

(21) Appl. No.: 16/225,245

(22) Filed: Dec. 19, 2018

Related U.S. Application Data
(63) Continuation of application No. PCT/US17/37409, filed on Jun. 14, 2017.
(60) Provisional application No. 62/355,442, filed on Jun. 28, 2016.

(51) Int. Cl. G02B 6/28; G02B 6/30; G02B 6/44; G02B 6/02; G02B 6/38

(52) U.S. Cl. CPC G02B 6/28; G02B 6/30; G02B 6/3847; G02B 6/4471; G02B 6/0218; G02B 6/4466

(57) ABSTRACT

A fiber optic connector assembly having a body connected to first and second tubular enclosures at their first ends is disclosed. The first tubular enclosure extends in a first direction. The second tubular enclosure extends in a second direction. An optical splitter is positioned in the body proximal to the first ends of the first tubular enclosure and the second tubular enclosure. A first waveguide extends from the optical splitter in the first direction through the first tubular enclosure. A second waveguide extends from the optical splitter in the second direction through the second tubular enclosure. A first fiber connector in optical communication with the first waveguide is connected to a second end of the first tubular enclosure. A second fiber connector in optical communication with the second waveguide and is connected to a second end of the second tubular enclosure. In some embodiments, the body may be sealed from environmental elements.

This application is a continuation of International Application No. PCT/US17/37409, filed on Jun. 14, 2017, which claims the benefit of priority to U.S. Application No. 62/355,442, filed on Jun. 28, 2016, both applications being incorporated herein by reference.

### FIELD

The disclosure relates generally to fiber optic connector assemblies, more particularly to fiber optic connector assemblies having an optical splitter positioned in-line with fiber optic connectors for use in fiber optic networks.

### BACKGROUND

As a result of the ever-increasing demand for broadband communications involving voice, video and data transmission, telecommunication and cable media service providers and/or operators have increasingly relied on fiber optics to provide large bandwidth telecommunication service to their subscribers. Fiber optic solutions have become the main part of telecommunication networks. Optical cables can transmit voice, data and video signals over very long distances at very high speed. Because of this, developments in fiber optic telecommunication networks have consistently focused on extending the optical fiber closer to the subscriber to the point that currently the subscriber can be connected directly to the fiber optic network through FTTx (fiber to the specific location “x”) technology, including FTTH technology (fiber-to-the-home), which provides an “all optical” communication network right to the subscribers at their homes. This deployment of optical fiber toward the subscriber is being driven by ever-increasing demand for more bandwidth, whether the optical fiber reaches all the way to the subscriber or not.

However, the subscriber's home may not be a separate, free-standing house, but an apartment building, referred to as a multiple dwelling unit (MDU). The apartment buildings may be very old and were built during a time when no one ever dreamed of broadband communications, fiber optic networks or the internet. In addition, construction techniques, materials and building codes may have been significantly different from what they are today. Moreover, there are different kinds of MDUs, each kind requiring a different kind of complicated cabling systems to retrofit a fiber optic network in the MDU. Typically, separate cables are used with each cable connected to one subscriber. Installation of many cables which provide the connection between a main distribution point (which usually is located in the basement or in another place of the building) and the subscriber may cause significant and numerous problems with routing through the wall or levels of the building, in addition to mounting and installing fiber optic equipment. As a result, such installations consume a lot of time and costs, particularly with regard to retrofitting such a network in existing buildings having current tenants.

Referring to FIG. 1, there is shown a conventional fiber optic network 100) installed in a typical MDU. The MDU 110 has multiple floors or distribution levels 112, four of which are shown in FIG. 1. Each floor 112 is provided optical service by a riser cable 114 extending vertically from a lower floor 112, which may be a basement (not shown in FIG. 1). The riser cable 114 has spaced apart access points 116 which may be set at the factory. In FIG. 1, the access points 116 have been set to align with each floor 112, but the access points 116 may be set for any appropriate spacing, for example, every other floor 112 based on the number of subscribers per floor 112 or to accommodate the architectural structure of the MDU 110.

The access point 116 may be a FlexNAP™ system provided by Corning Optical Communications LLC of Hickory, N.C. At the access point 116, one or more optical fibers of the riser cable 114 separate or are tapped off from the riser cable 114 by a tether cable 118 which routes to a distribution box 120 located at the particular floor 112. The distribution box 120 may be a fiber distribution terminal (FDT) or may be a local convergence point (LCP). In the case of an FDT, the tether cable 118 may be a multi-fiber cable and the distribution box 120 may be used to interconnect each optical fiber in the tether cable 118 to an optical fiber in a subscriber drop cable 122, which routes to a subscriber premises 124 to provide optical communication service to that particular subscriber. In such case, the distribution box 120 will have a patch panel to make such interconnections. Alternatively, the distribution box 120 may include an optical splitter 126 and function as an LCP. Instead of the optical fiber in the tether cable 118 being directly connected to an optical fiber in the subscriber drop cable 122, the optical fiber is connected to the optical splitter 126 which splits the optical signal in the optical fiber into multiple optical signals. Each of the split optical signals is carried by a separate optical fiber and interconnects with an optical fiber in the subscriber drop cable 122 routed to the subscriber premises 124.

An LCP is shown in the break-out detail in FIG. 1. Referring to the detail, the tether cable 118 separates from the riser cable 114 at the access point 116 and extends toward the optical splitter 126. It should be noted that, although the riser cable 114 and the access point 116 are shown being routed within the distribution box 120, the riser cable 114 and the access point 116 may be positioned outside of the distribution box 120, and, may even be located outside of the MDU 110 and be exposed to environmental elements. The optical splitter 126 and input terminal blocks 128 may be positioned in a separate section or sub-enclosure 130 of the distribution box 120. The tether cable 118 may enter the sub-enclosure 130 through a port or be connected into the sub-enclosure by a suitable fiber optic connector 132. An optical fiber 134 from the tether cable 118 connects to the optical splitter 126 through input terminal blocks 128 by way of input optical fiber 136. The optical splitter 126 splits the optical signal carried by the input optical fiber 136 into multiple optical signals. In the detail for FIG. 1, the optical splitter 126 splits the optical fiber into four optical signals each of which is carried by a separate output optical fiber 138. The output optical fibers 138 route to output terminal blocks 140 and interconnect to the output fibers 142. Each output fiber 142 may be included in a subscriber drop cable 122 with individual subscriber drop cables 122 bundled together into a bundled drop cable 144 using a helical wrap. The bundled drop cable 144 and, therefore, the subscriber drop cables 122 connect to the distribution box 120 through a multi-fiber connector 146 and extend to the subscriber premises 124. A drop box 148 at the subscriber premises 124 receives the bundled drop cable 144 and one of the subscriber drop cables 122 separates from the bundled drop cable 144 and routes to the subscriber premises 124.

Whether the distribution box 120 is a FDT or a LCP, sufficient space on the floor 112 is required for mounting and installing the distribution box 120, and for connecting the tether cable 118 and the subscriber drop cable 122 to the distribution box 120. This requirement becomes costly, not only with respect to the material necessary for each floor 112, but also, for the labor involved with such installation. This is particularly applicable in the event the fiber optic network is being retrofitted into an existing MDU, and increasingly problematic the older the MDU.

Consequently, there is an unresolved need for devices that provide better options for optical fiber deployments.

No admission is made that any reference cited herein constitutes prior art. Applicant expressly reserves the right to challenge the accuracy and pertinence of any cited documents.

### SUMMARY

One embodiment of the disclosure relates to a fiber optic connector assembly comprising a body. The fiber optic connector assembly comprises a first tubular enclosure having s a first end and a second end and connected to the body adjacent the first end of the first tubular enclosure, and extended in a first direction. The fiber optic connector assembly also comprises a second tubular enclosure having a first end and a second end and connected to the body adjacent the first end of the second tubular enclosure, and is extended in a second direction. The fiber optic connector assembly also comprises an optical splitter positioned in the body proximal to the first end of the first tubular enclosure and the first end of the second tubular enclosure. The fiber optic connector assembly also comprises a first waveguide extended from the optical splitter in the first direction through the first tubular enclosure. The fiber optic connector assembly also comprises a second waveguide extended from the optical splitter in the second direction through the second tubular enclosure. The fiber optic connector assembly also comprises a first fiber connector in optical communication with the first waveguide and connected adjacent the second end of the first tubular enclosure. The fiber optic connector assembly also comprises a second fiber connector in optical communication with the second waveguide and connected adjacent to the second end of the second tubular enclosure.

Another embodiment of the disclosure relates to a fiber optic connector assembly. The fiber optic connector assembly comprises a body having an interior. The fiber optic connector assembly also comprises a first tubular enclosure having a first end and a second end. The first tubular enclosure is connected to the body adjacent the first end of the first tubular enclosure, and extends in a first direction. The fiber optic connector assembly also comprises a second tubular enclosure having a first end and a second end connected to the body adjacent the first end of the second tubular enclosure, and extended in a second direction. The fiber optic connector assembly also comprises an optical splitter positioned in the body proximal to the first end of the first tubular enclosure and the first end of the second tubular enclosure. The fiber optic connector assembly also comprises a first optical fiber extended from the optical splitter in the first direction through the first tubular enclosure. The fiber optic connector assembly also comprises a second optical fiber extended from the optical splitter in the second direction through the second tubular enclosure. The fiber optic connector assembly also comprises a first fiber connector in optical communication with the first optical fiber and connected to the second end of the first tubular enclosure. The fiber optic connector assembly also comprises a second fiber connector in optical communication with the second optical fiber and connected to the second end of the second tubular enclosure. The body is sealed against environmental elements.

Yet another embodiment of the disclosure relates to a method of making a fiber optic connector assembly. The method comprises connecting a first tubular enclosure having a first end and a second end to a body adjacent to the first end of the first tubular enclosure, and extending the first tubular enclosure in a first direction. The method also comprises connecting a second tubular enclosure having a first end and a second end to the body adjacent to the first end of the second tubular enclosure, and extending the second tubular enclosure in a second direction. The method also comprises positioning an optical splitter in the body proximal to the first end of the first tubular enclosure and the first end of the second tubular enclosure, extending through the first tubular enclosure a first optical fiber from the optical splitter in the first direction, and extending through the second tubular enclosure a second optical fiber from the optical splitter in the second direction. The method also comprises providing a first fiber connector in optical communication with the first optical fiber and connecting the first fiber connector to the second end of the first tubular enclosure, and providing a second fiber connector in optical communication with the second optical fiber and connecting the second fiber connector to the second end of the second tubular enclosure. The method also comprises sealing the body to inhibit environmental elements.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a is a partial elevation view of a multiple dwelling unit (MDU) with a fiber optic network according to the prior art installed therein and connecting subscriber premises located on several floors to optical communication service;

FIG. 2 is a schematic diagram of a fiber optic connector assembly having a body with tubular enclosures extending therefrom and connecting to fiber optic connectors, and an optical splitter positioned in the body with optical waveguides extending through the tubular enclosures to the fiber optic connectors, and wherein the fiber optic connectors are in optical communication with the waveguides, according to an exemplary embodiment;

FIG. 3 is a plan view of the optical splitter of FIG. 2, comprising a splitter housing and first waveguide and second waveguide connected thereto;

FIG. 4A is a plan view of the optical splitter of FIG. 3 including a splitter module, an input waveguide and an output waveguide sealed in the body to inhibit environmental effects;

FIG. 4B is a partial perspective view of the optical splitter of FIG. 3, including the splitter module, an input waveguide and an output waveguide positioned in a splitter housing;

FIG. 4C is a partial plan view of the optical splitter of FIG. 3, including the splitter module, an input waveguide and an output waveguide positioned in a splitter housing with a heat-shrink material applied thereto;

FIG. 5 is a plan view of the fiber optic connector assembly of FIG. 2 shown in an assembled configuration with a first fiber connector, the body, and the second fiber connector;

FIG. 6A is a cross-sectional view of the body of FIG. 5 taken along line 6A-6A:

FIG. 6B is a cross-sectional view of the second tubular enclosure of FIG. 5 taken along line 6B-6B;

FIG. 6C is a cross-sectional view of the single-fiber connector of FIG. 5 taken along line 6C-6C:

FIG. 6D is a cross-sectional view of the multi-fiber connector of FIG. 5 taken along line 6D-6D;

FIG. 7 is a flow-chart diagram illustrating an exemplary process for making a fiber optic connector assembly having an in-line splitter;

FIG. 8 is a partial elevation view of an access point of a riser cable connected to the fiber optic assembly of FIG. 5, including a tether cable connected to a single-fiber connector and a multi-fiber connector; and

FIG. 9 is a partial elevation view a MDU with a fiber optic network installed therein, including the fiber optic assembly according to FIG. 5 connected to access points on the riser cable to extend the fiber optic network to subscriber premises located on several floors.

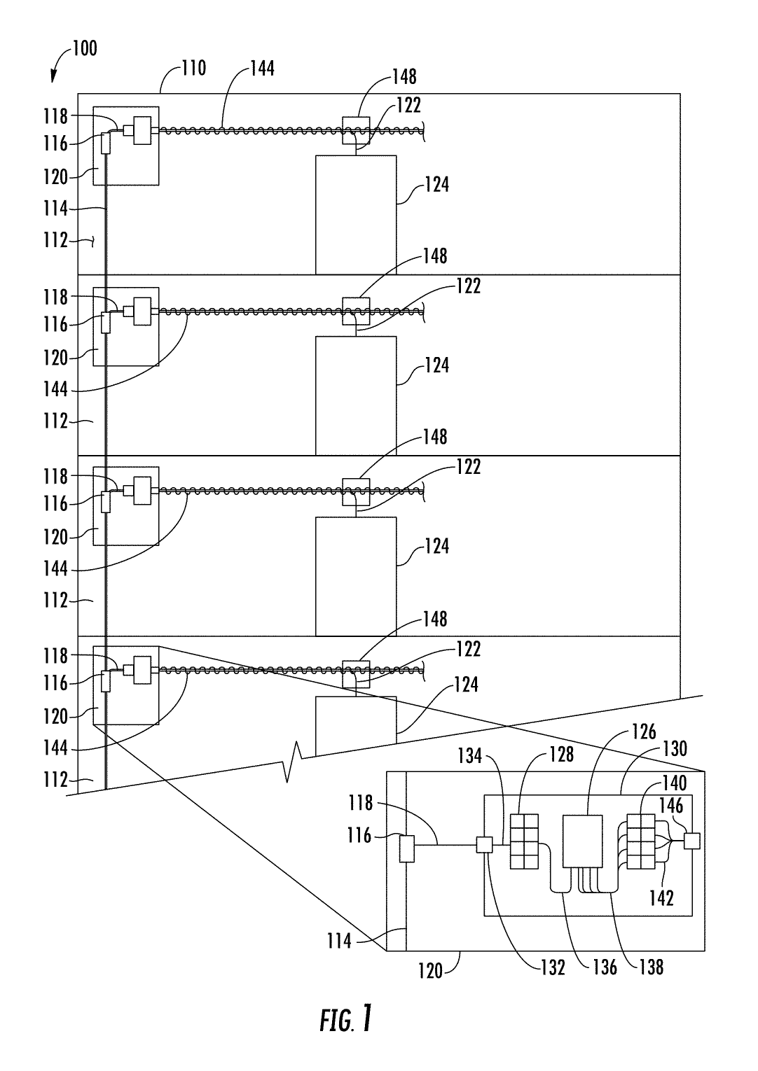

### DETAILED DESCRIPTION

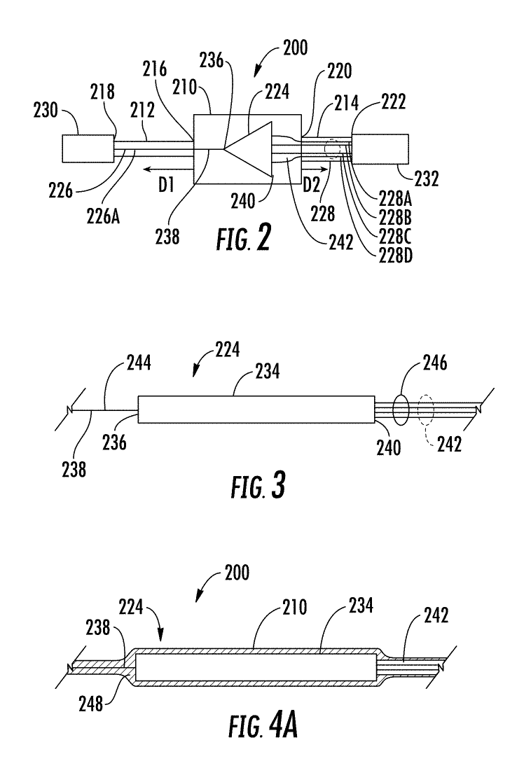

Referring now to FIG. 2, there is shown a schematic diagram of a fiber optic connector assembly 200. The fiber optic connector assembly 200 includes a body 210, a first tubular enclosure 212, and a second tubular enclosure 214. The first tubular enclosure 212 has a first end 216 and a second end 218 and is connected to the body 210 adjacent to the first end 216 of the first tubular enclosure 212 and extends in a first direction “D1”. The second tubular enclosure 214 has a first end 220 and a second end 222 and is connected to the body 210 adjacent the first end 220 of the second tubular enclosure 214 and extends in a second direction “D2”. An optical splitter 224 is positioned in the body 210 proximal to the first end 216 of the first tubular enclosure 212 and the first end 220 of the second tubular enclosure 214. A first waveguide 226 extends from the optical splitter 224 in the first direction “D1” through the first tubular enclosure 212. A second waveguide 228 extends from the optical splitter 224 in the second direction “D2” through the second tubular enclosure 214. A first fiber connector 230 is in optical communication with the first waveguide 226 and is connected to the first tubular enclosure 212 adjacent to the second end 218 of the first tubular enclosure 212. A second fiber connector 232 is in optical communication with the second waveguide 228 and is connected to the second tubular enclosure 214 adjacent to the second end 222 of the second tubular enclosure 214. The body 210 may be sealed against environmental elements as needed for the desired application. For instance, outdoor applications may require robust sealing and indoor applications may not require the same level of environmental protection.

In FIG. 2, the first waveguide 226 is shown as having one optical signal 226A and the second waveguide 228 is shown as having four optical signals 228A, 228B, 228C, 228D. In this regard, the optical splitter 224 is shown as splitting the optical signal 226A into four optical signals 228A, 228B, 228C, 228D. In this sense, the first waveguide 226 may be considered as carrying non-split optical signal(s) and the second waveguide 228 may be considered as carrying split optical signals. In FIG. 2, the optical splitter 224 has an input 236 which includes an input waveguide 238 in optical communication with the first waveguide 226; and an output 240 which includes an output waveguide 242 in optical communication with the second waveguide 228. For purposes of this description, the term “input” is used to denote and relate to an interface of the optical splitter 224 directed to the non-split optical signal(s), and, accordingly, as related to the first waveguide 226 and associated optical fibers and cables. The term “output” is used to denote and relate to an interface of the optical splitter 224 directed to the split optical signals, and, accordingly as related to the second waveguide 228 and associated optical fibers and cable. However, it should be understood that the optical splitter 224 is a bi-directional device, and the terms “input” and “output” are used only for convenience purposes and are not intended to limit the bi-directionality of the optical splitter 224. In other words, the optical splitter 224 may also be viewed as combining optical signals, in which case the split optical signals may be considered as an input to the optical splitter 224 and the non-split optical signal(s) may be considered as an output to the optical splitter 224.

Referring now to FIG. 3, a plan view of the optical splitter 224 is shown. Optical splitter 224 is shown as having a splitter module 234 with the input waveguide 238 and the output waveguide 242 extending from the splitter module 234. The input waveguide 238 may be continuous with the first waveguide 226, as shown in FIG. 2, or alternatively, input waveguide 238 and first waveguide 226 may be in optical communication through a splice or other connection item, which is not shown in FIGS. 2 and 3. Similarly, the output waveguide 242 may be continuous with the second waveguide 228, as shown in FIG. 2, or alternatively, output waveguide 242 and second waveguide 228 may be in optical communication through a splice or other connection item, which is not shown in FIGS. 2 and 3.

Continuing with reference to FIGS. 2 and 3, the optical splitter 224 may be determined to have a “M:N” split ratio, where “M” is the number of optical signals of the first waveguide 226 of the input 236, and “N” is the number of optical signals of the second waveguides 228 of the output 240. The number “M” may be one or greater, and the number “N” may be selected from one of 4, 8, 16, and 32. Each optical signal may be carried by individual optical fibers. As such, the first waveguide 226 and the input waveguide 238 may include a first optical fiber 244, which may be one optical fiber or multiple optical fibers. For example, the first optical fiber 244 may include one or two 250-micron optical fibers, or be fabricated with 900-micron tight buffer. The second waveguide 228, and the output waveguide 242 may include a second optical fiber 246, which may be one optical fiber or multiple optical fibers. Since the second optical fiber 246 may include 4, 6, 8, 16, or 32 optical fibers, the second optical fiber 246 may be ribbonized and in combinations of 4 or 8 optical fibers, or any other suitable ribbon combination. In FIGS. 2 and 3, the first optical fiber 244 is shown as one optical fiber and the second optical fiber 246 is shown as ribbonized with four optical fibers.

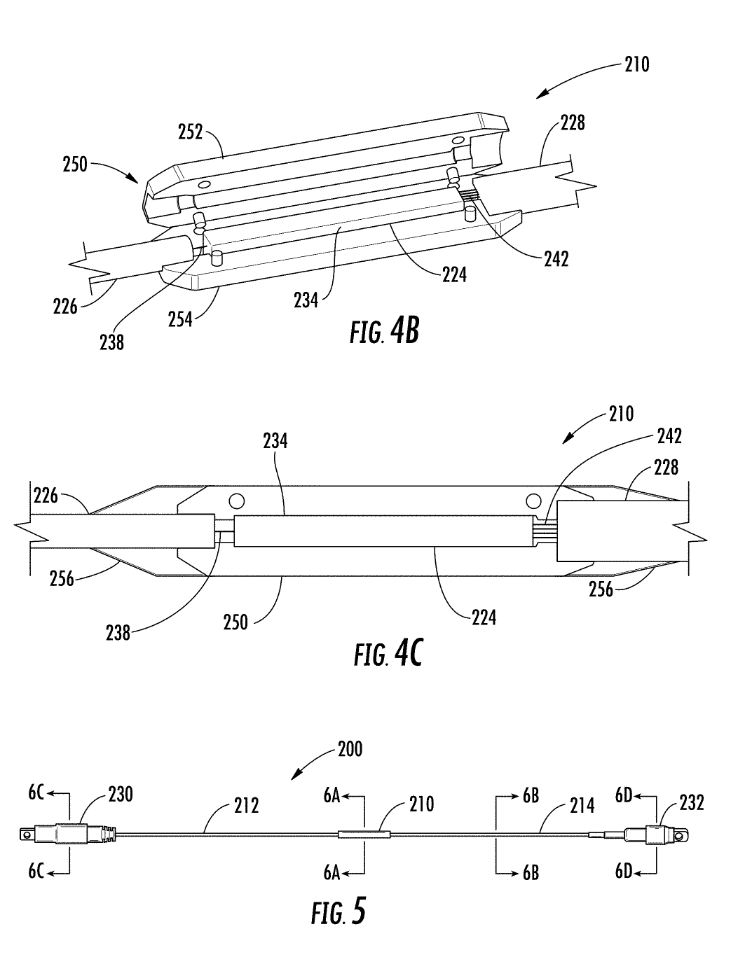

Referring to FIG. 4A, a partial plan view of the fiber optic connector assembly 200 is shown. In FIG. 4A, the body 210 is shown as being constructed from material to seal the optical splitter 224 including the splitter module 234, input waveguide 238 and output waveguide 242 against environmental elements. However, other embodiments may not require the same level of protection from environmental effects for the body. The body 210 may be overmolded such as with a polymeric encapsulant 248. The polymeric encapsulant 248 provides a water-impermeable barrier to the body 210 and/or improves the robustness of the fiber optic connector assembly 200. In some embodiments, the polymeric encapsulant 248 may be polyurethane. In other contemplated embodiments, one or more heat-shrink tubes or wraps may be used in place of or in conjunction with the overmolded polymeric encapsulant 248 (e.g., underneath the polymeric encapsulant 248 or over lengthwise end-portions of the polymeric encapsulant 248, extending over adjoining first tubular enclosure 212 and/or second tubular enclosure 214). Additionally, a potting material may be used to seal the optical splitter 224.

Referring now to FIGS. 4B and 4C, partial perspective and plan views, respectively, of the body 210 are shown. As shown in FIGS. 4B and 4C, the body 210 includes a splitter housing 250 constructed of a first shell 252 and a second shell 254. The optical splitter 224 having a splitter module 234, input waveguide 238 and output waveguide 242 may be positioned in the second shell 254. Additionally, the first waveguide 226 is shown connected to the input waveguide 238, and the second waveguide 228 is shown as connected to the output waveguide 242 in the second shell 254. The first shell 252 may then be mated to the second shell 254 to close and seal the splitter housing 250, and thereby the body 210. A heat-shrink material 256 may then be applied to cover and seal the body, including the splitter housing 250 with the splitter module 238, the input waveguide 238, and the second waveguide 228; as well as first waveguide 226 and the second waveguide 228. In this manner, the splitter module 234, the input waveguide 238, the second waveguide 228, the connection between the input waveguide 238 and the first waveguide 226, and the connection between the output waveguide 242 and the second waveguide 228 may be sealed against environmental elements,

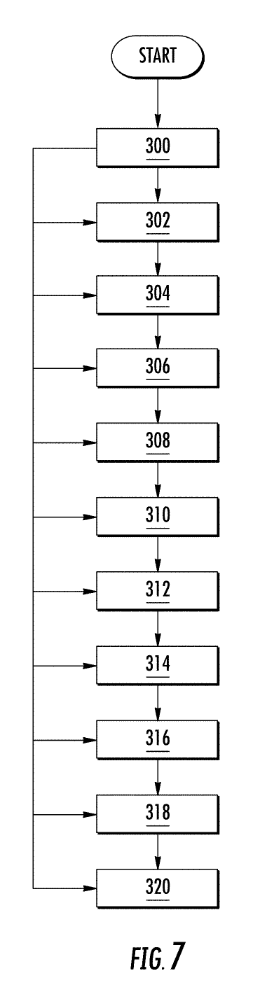

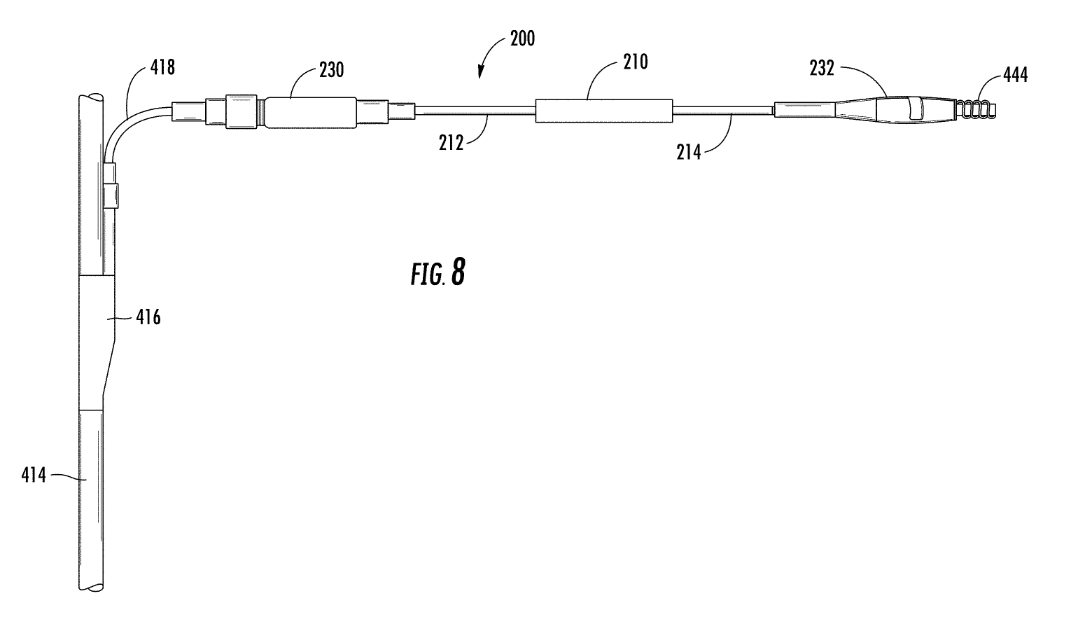

According to an exemplary embodiment, the overmolded portion of the fiber optic connector assembly 200 has a particularly low-profile. As a non-limiting example, the overmolding may allow the body 210 to have a maximum transverse cross-section that is about the same size or less than a maximum transverse cross-section of the first fiber connector 230 or a maximum transverse cross-section of the second fiber connector 232. As another non-limiting example, the overmolding may allow the body 210 to have a maximum transverse cross-section that is no greater than twice a maximum transverse cross-section of the first fiber connector 230 or a maximum transverse cross-section of the second fiber connector 232. This facilitates the fiber optic connector assembly's 200 maneuverability through narrow ducts and openings in the MDU. This is discussed in additional detail with reference to FIGS. 6A, 6B, 6C and 6D below.

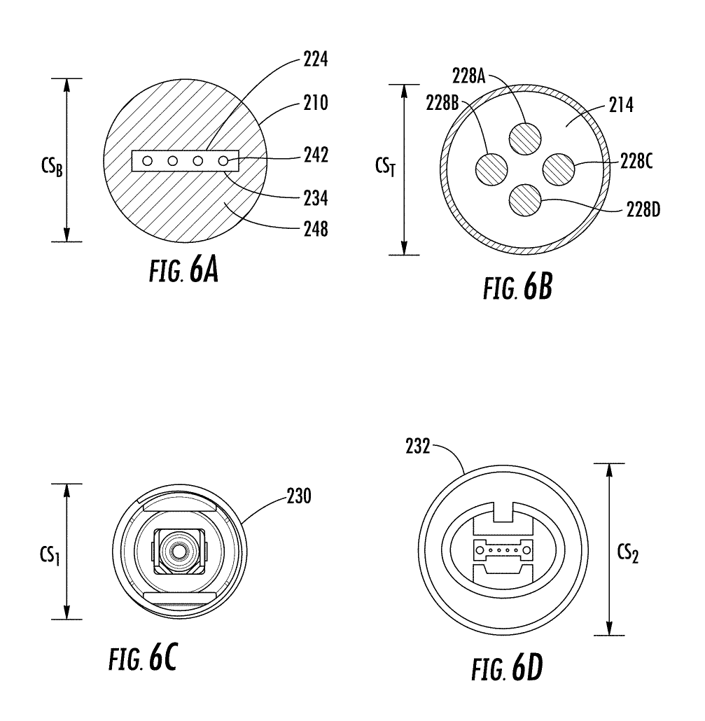

Referring to FIG. 5, a plan view of the explanatory fiber optic connector assembly 200 shown in an assembled configuration. In FIG. 5, the body 210 is shown connected to the first fiber connector 230 by the first tubular enclosure 212 and connected to the second fiber connector 232 by the second tubular enclosure 214. The first fiber connector 230 may be a single-fiber connector, such as, SC and LC type connector, and may be a hardened connector suitable for use outdoors. The fiber optic connectors may have any suitable securing mechanism for securing a mating optical connector such as a push-pull mechanism, a latching mechanism, a bayonet mechanism, a threaded mechanism or the like.

In such case, the first fiber connector 230 may be an OptiTap® connector provided by Corning Optical Communications LLC of Hickory, N.C. The second fiber connector 232 may be a multi-fiber connector, such as an MPO type of connector, and may be a hardened connector suitable for use outdoors. In such case, the second fiber connector 232 may be an OptiTip® connector provided by Corning Optical Communications LLC of Hickory, N.C. However, other suitable types of first and second fiber connectors are possible according to the concepts disclosed herein. The first tubular enclosure 212 may be a cable jacket or may be a plastic tube manufactured from material that provides protection for the waveguides, including from outside environmental elements, and is flexible for installing and routing in conduits and raceways in a MDU. Similarly, the second tubular enclosure 214 may be a cable jacket or may be a plastic tube manufactured from material that provides protection for the waveguides, including from outside environmental elements, and is flexible for installing and routing in conduits and raceways in a MDU.

FIGS. 6A and 6B are cross-sectional views of the fiber optic connector assembly 210 taken at different locations, and FIGS. 6c and 6D are cross-sectional views of the first fiber connector 230 and second fiber connector 232, respectively. Turning first to FIG. 6A, a cross-section of body 210 taken along lines 6A-6A of FIG. 5 is shown. The body 210 is shown with polymeric encapsulant 248 disposed around the splitter module 234 of the optical splitter optical 224 with output waveguide 242. In FIG. 6A, the body 210 is shown as having a maximum transverse cross-section denoted by “CS_{B}”. Referring next to FIG. 6B, a cross-section of second tubular enclosure 214 taken along lines 6B-6B of FIG. 5 is shown. Optical fibers 228 A. 228B, 228C and 228D extend through the second tubular enclosure 214. In FIG. 6B, the second tubular enclosure 214 is shown as having a maximum transverse cross-section denoted by “CS_{T}”. Referring next to FIG. 6C, a cross-section of first fiber connector 230 taken along lines 6C-6C of FIG. 5 is shown. In FIG. 6C, the first fiber connector 230 is shown as having a maximum transverse cross-section denoted by “CS₁”. The first fiber connector 230 may be a hardened single-fiber connector. Referring next to FIG. 6D, a cross-section of second fiber connector 232 taken along lines 6D-6D of FIG. 5 is shown. In FIG. 6D, the second fiber connector 232 is shown as having a maximum transverse cross-section denoted by “CS₂”. The second fiber connector 232 may be a hardened, multi-fiber hardened connector.

Generally, the maximum transverse cross-section CS_{B} of the body 210 may be larger than the maximum transverse cross-section CS_{T} of the second tubular enclosure 214. In other words, CS_{B} may generally be greater than CS_{T}. However, as discussed with respect to FIG. 4 above, to facilitate the fiber optic connector assembly's 200 maneuverability through narrow ducts and openings in the MDU during installation, the maximum transverse cross-section CS_{B} of the body 210 may be the same or less than the maximum transverse cross-section CS₁ of the first fiber connector 230, or a maximum transverse cross-section CS₂ of the second fiber connector 232. In this regard, CS_{B} may be the same or less than the larger of CSI or CS₂. Moreover, the maximum transverse cross-section CS_{B} of the body 210 may be no greater than twice the maximum transverse cross-section CSI of the first fiber connector 230 or the maximum transverse cross-section CS₂ of the second fiber connector 232. In this regard, CS_{B} may be no greater than twice the larger of CS₁ or CS₂.

Referring now to FIG. 7, a method of making a fiber optic connector assembly 200 is illustrated. The method may include connecting a first tubular enclosure having a first end and a second end to a body adjacent to the first end of the first tubular enclosure (block 300 in FIG. 7), and extending the first tubular enclosure in a first direction (block 302 in FIG. 7). The method also may include connecting a second tubular enclosure having a first end and a second end to the body adjacent to the first end of the second tubular enclosure (block 304 in FIG. 7), and extending the second tubular enclosure in a second direction (block 306 in FIG. 7). The method also may include positioning an optical splitter in the body proximal to the first end of the first tubular enclosure and the first end of the second tubular enclosure (block 308 in FIG. 7), extending through the first tubular enclosure a first optical fiber from the optical splitter in the first direction (block 310 in FIG. 7), and extending through the second tubular enclosure a second optical fiber from the optical splitter in the second direction (block 312 in FIG. 7). The method also may include, establishing a M:N split ratio of the optical splitter, wherein M is the number of optical waveguides of an input of the optical splitter and N is the number of optical waveguides of an output of the optical splitter (block 314 in FIG. 7), where M may be one or greater, and N is selected from one of 4, 8, 16, and 32. The method also may include connecting to the second end of the first tubular enclosure a first fiber connector in optical communication with the first optical fiber (block 316 in FIG. 7). The first fiber connector may be a single-fiber connector. The method also may provide connecting to the second end of the second tubular enclosure a second fiber connector in optical communication with the second optical fiber (block 318 in FIG. 7). The second fiber connector is a multi-fiber connector. The method may also further include sealing the body to inhibit the effect of environmental elements (block 320 in FIG. 7) if desired. The degree of sealing may depend on the intended environment for the cable assembly.

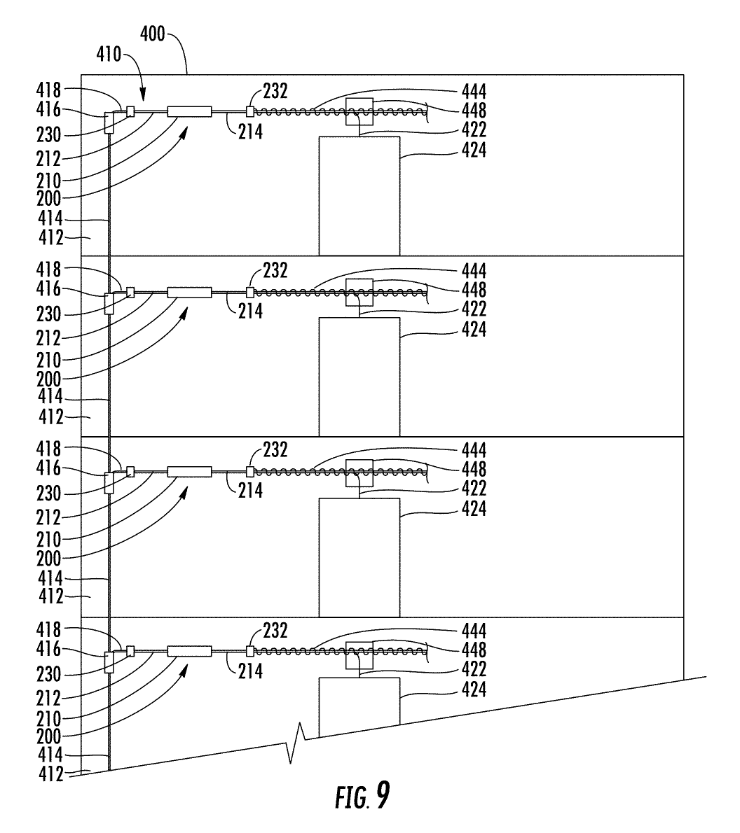

FIG. 8 is a partial detail view of a fiber optic connector assembly 200 with first fiber connector 230 connected to a tether cable 418 of an access point 416 of riser cable 414. In FIG. 8, the first fiber connector 230 is shown as a hardened single-fiber connector, for example, an OptiTap connector, attached to the end of the tether cable 418. The first fiber connector 230 connects to the body 210 by first tubular enclosure 212. The second fiber connector 232 is connected to the bundled drop cable 444. The second fiber connector 232 is connected to the body 210 by second tubular enclosure 214.

Referring to FIG. 9, there is shown a fiber optic network 400 installed in a typical MDU 410. The MDU 410 has multiple floors or distribution levels 412, four of which are shown in FIG. 9. Each floor 412 is provided optical service by a riser cable 414 extending vertically from a lower floor 412, which may be a basement (not shown in FIG. 9). The riser cable 414 has spaced apart access points 416 which may be set at the factory. In FIG. 9, the access points 416 have been set to align with each floor 412. However, there is no distribution box, whether a FDT or LCP, in the fiber optic network of FIG. 9. Instead, a fiber optic connector assembly 200 is connected to the riser cable 414 through the tether cable 418 at each floor 412 and to a subscriber drop cable 422 bundled in a bundled drop cable 444 to provide optical communication service to the subscriber premises 424 on each floor 412 through drop box 448. However, the concepts disclosed herein may be used in other applications such as outdoor environments, industrial applications or other suitable deployments where optical splitters are desired with plug and play connectivity.

The cable assemblies disclosed are advantageous since they provide flexibility and scalability for the network operator since the cable assembly can be removed or added as needed. Moreover, the cable assembly can be easily replaced as desired. Consequently, the network operator has more flexibility for placement of the splitters in the network and can accommodate changes in subscriber take-rates, new subscribers or the like.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A fiber optic connector assembly, comprising:
a body;
a first tubular enclosure having a first end and a second end and connected to the body adjacent to the first end of the first tubular enclosure, and extended in a first direction;
a second tubular enclosure having a first end and a second end and connected to the body adjacent to the first end of the second tubular enclosure, and extended in a second direction;
an optical splitter positioned in the body proximal to the first end of the first tubular enclosure and the first end of the second tubular enclosure;
a first waveguide extended from the optical splitter in the first direction through the first tubular enclosure;
a second waveguide extended from the optical splitter in the second direction through the second tubular enclosure;
a first fiber connector in optical communication with the first waveguide and connected adjacent to the second end of the first tubular enclosure; and
a second fiber connector in optical communication with the second waveguide and connected adjacent to the second end of the second tubular enclosure.

2. The fiber optic connector assembly of claim 1, wherein the body has a maximum transverse cross-section that is no greater than twice a maximum transverse cross-section of the first fiber connector or a maximum transverse cross-section of the second fiber connector.

3. The fiber optic connector assembly of claim 1, wherein the body has a maximum transverse cross-section that is about the same size or less than a maximum transverse cross-section of the first fiber connector or a maximum transverse cross-section of the second fiber connector.

4. The fiber optic connector assembly of claim 1, wherein the body is sealed by an overmold applied over the body.

5. The fiber optic connector assembly of claim 1, wherein the body is sealed by a potting material in the body.

6. The fiber optic connector assembly of claim 1, wherein the body is sealed by a heat-shrink material applied over the body.

7. The fiber optic connector assembly of claim 1, wherein the first waveguide comprises a first optical fiber.

8. The fiber optic connector assembly of claim 7, wherein the first optical fiber comprises multiple optical fibers.

9. The fiber optic connector assembly of claim 8, wherein the first optical fiber is ribbonized.

10. The fiber optic connector assembly of claim 1, wherein the second waveguide comprises a second optical fiber.

11. The fiber optic connector assembly of claim 10, wherein the second optical fiber comprises multiple optical fibers.

12. The fiber optic connector assembly of claim 11, wherein the second optical fiber is ribbonized.

13. The fiber optic connector assembly of claim 1, wherein the first fiber connector comprises a single-fiber connector.

14. The fiber optic connector assembly of claim 1, wherein the first fiber connector comprises a hardened connector suitable for outdoor environments.

15. The fiber optic connector assembly of claim 14, wherein the hardened connector comprises an SC and LC type connector.

16. The fiber optic connector assembly of claim 1, wherein the second fiber connector comprises a multi-fiber connector.

17. The fiber optic connector assembly of claim 1, wherein the second fiber connector comprises a hardened connector suitable for outdoor environments.

18. The fiber optic connector assembly of claim 17, wherein the hardened connector comprises a MPO type connector.

19. The fiber optic connector assembly of claim 1, wherein the optical splitter comprises a M:N split ratio, wherein M is the number of optical waveguides of an input of the optical splitter and N is the number of optical waveguides of an output of the optical splitter.

20. The fiber optic connector assembly of claim 19, wherein M is one or greater.

21. The fiber optic connector assembly of claim 19, wherein N is selected from one of 4, 8, 16, and 32.

22. The fiber optic connector assembly of claim 1, wherein the body is sealed from environmental effects.

23. A fiber optic connector assembly, comprising:
a body having an interior;
a first tubular enclosure having a first end and a second end, the first tubular enclosure connected to the body adjacent to the first end of the first tubular enclosure, and extended in a first direction;
a second tubular enclosure having a first end and a second end and connected to the body adjacent to the first end of the second tubular enclosure, and extended in a second direction;
an optical splitter positioned in the body proximal to the tubular enclosure first end of the first tubular enclosure and the first end of the second tubular enclosure;
a first optical fiber extended from the optical splitter in the first direction through the first tubular enclosure;
a second optical fiber extended from the optical splitter in the second direction through the second tubular enclosure;
a first fiber connector in optical communication with the first optical fiber and connected to the second end of the first tubular enclosure; and
a second fiber connector in optical communication with the second optical fiber and connected to the second end of the second tubular enclosure, and
wherein the body is sealed against environmental elements.

24. The fiber optic connector assembly of claim 23, wherein the body has a maximum transverse cross-section that is no greater than twice a maximum transverse cross-section of the first fiber connector or a maximum transverse cross-section of the second fiber connector.

25. The fiber optic connector assembly of claim 23, wherein the body has a maximum transverse cross-section that is about the same size or less than a maximum transverse cross-section of the first fiber connector or a maximum transverse cross-section of the second fiber connector.

26. The fiber optic connector assembly of claim 23, wherein the first tubular enclosure comprises a cable jacket.

27. The fiber optic connector assembly of claim 23, wherein the second tubular enclosure comprises a cable jacket.

28. The fiber optic connector assembly of claim 23, wherein the first tubular enclosure comprises a plastic tube.

29. The fiber optic connector assembly of claim 23, wherein the second tubular enclosure comprises a plastic tube.

30. The fiber optic connector assembly of claim 23, wherein the body comprises a cover.

31. The fiber optic connector assembly of claim 30, wherein the interior of the body is accessed by opening the cover.

32. The fiber optic connector assembly of claim 31, wherein a potting material is disposed within the body.

33. The fiber optic connector assembly of claim 23, wherein the body has a maximum outer transverse cross-sectional dimension less than an outer transverse cross-sectional dimension of the larger of the first fiber connector and the second fiber connector.

34. A method of making a fiber optic connector assembly, comprising:
connecting a first tubular enclosure having a first end and a second end to a body adjacent to the first end of the first tubular enclosure, and extending the first tubular enclosure in a first direction;
connecting a second tubular enclosure having a first end and a second end to the body adjacent to the first end of the second tubular enclosure, and extending the second tubular enclosure in a second direction;
positioning an optical splitter in the body proximal to the first end of the first tubular enclosure and the first end of the second tubular enclosure;
extending through the first tubular enclosure a first optical fiber from the optical splitter in the first direction;
extending through the second tubular enclosure a second optical fiber from the optical splitter in the second direction;
providing a first fiber connector in optical communication with the first optical fiber and connecting the first fiber connector to the second end of the first tubular enclosure; and
providing a second fiber connector in optical communication with the second optical fiber and connecting the second fiber connector to the second end of the second tubular enclosure second end.

35. The method of claim 34, wherein the first fiber connector is a single-fiber connector.

36. The method of claim 34, wherein the second fiber connector is a multi-fiber connector.

37. The method of claim 34, further comprising, establishing a M:N split ratio of the optical splitter, wherein M is the number of optical waveguides of an input of the optical splitter and N is the number of optical waveguides of an output of the optical splitter.

38. The method of claim 37, wherein M is one or greater.

39. The method of claim 37, wherein N is selected from one of 4, 8, 16, and 32.

40. The method of claim 37, further comprising a sealing body.
